(19) United States
(12) Patent Application Publication
(10) Pub. No.: US 2012/0012588 A1
(43) Pub. Date: Jan. 19, 2012

(54) Remote solid waste box lock

(76) Inventors: Christopher A. Shield, Houston, TX (US); Danielle R. Forget Shield, Houston, TX (US)

(21) Appl. No.: 12/804,251

(22) Filed: Jul. 16, 2010

(51) Int. Cl. B65D 45/00; B23P 17/00

(52) U.S. Cl. 220/315; 29/525.01

(57) ABSTRACT

Apparatus and methods for securing and/or tracking a solid waste container using a locking mechanism.

### FIELD OF THE INVENTION

This invention relates to locking mechanisms for solid waste containers, and more particularly to use and manufacture of, or systems for a remote locking mechanism to secure a solid waste container to minimize the potential theft of the solid waste container. The invention further relates to the use and manufacture of, or systems for the securing and tracking the location of solid waste containers with a locking mechanism.

### BACKGROUND OF THE INVENTION

This invention relates in general to a locking mechanism for preventing the theft of roll-off or solid waste containers used in the collection of non-hazardous, hazardous, medical, household, or construction waste or debris, generally known as solid waste.

As discussed in U.S. Pat. No. 4,996,855 titled Lock Mechanism, issued on Mar. 5, 1991, to Havenga, there is widespread use of roll-off containers in the solid waste industry today. These containers are rather large and generally come in 20 yard, 30 yard or 40 yard sizes and have an approximate length of 20 feet, an approximate width of 8 feet, and a height of approximately 4 feet to 6 feet. These solid waste containers are transported between solid waste collection sites by hoist trucks. Generally speaking the truck delivers the container to a solid waste collection site, which may be an industrial plant, construction project or site, institutional facility, residence or a business. When the truck arrives at the site the solid waste container or “box” is rolled off of the truck using methods and equipment commonly known in the solid waste industry. Once the solid waste container is filled with solid waste, the solid waste container is rolled back onto the truck. The truck then delivers the solid waste container and solid waste to a disposal facility, which typically is a landfill, transfer station, or other permitted disposal site. After the solid waste container is emptied at the disposal facility the box is reused in a manner as described above.

These solid waste containers tend to be large metal structures that are expensive to manufacture and maintain. Furthermore, these solid waste containers may have special features, for example, dewatering, gaskets, liners, tops, and/or tarps, all of which increase the cost of the solid waste container.

In addition to the lock mechanism described in U.S. Pat. No. 4,996,855, numerous locks have been designed to prevent the theft of trailers. For example, a trailer having a ball coupler may have a lock installed which covers the ball when the trailer is not in use for the purpose of preventing a thief from coupling to the ball. The following listed patents show a variety of locks for the purpose of preventing the theft of trailers and other types of vehicles: U.S. Pat. No. 4,774,823 issued to Callison on Oct. 4, 1988; U.S. Pat. No. 4,693,096 issued to Mercer on Sep. 15, 1987; U.S. Pat. No. 4,538,827 issued to Plifka on Sep. 3, 1985; U.S. Pat. No. 4,480,450 issued to Brown on Nov. 6, 1984; U.S. Pat. No. 4,409,804 issued to Sork on Oct. 18, 1983; U.S. Pat. No. 4,380,160 issued to Hoffman on Apr. 19, 1983; U.S. Pat. No. 4,376,544 issued to Sette et al. on Mar. 15, 1983; U.S. Pat. No. 3,782,761 issued to Cardin, Sr. on Jan. 1, 1974; and U.S. Pat. No. 2,571,349 issued to Eckles on Oct. 16, 1951.

A problem commonly encountered in the solid waste disposal industry due to interchangeability of the solid waste containers is box theft, because anyone with a suitable hoist truck can remove the box. Another commonly encountered issue is that the solid waste containers are commonly located in harsh environments and exposed to the elements twenty four hours a day 365 days a year. These conditions may cause standard mechanical or combination locks in combination with mechanisms similar to U.S. Pat. No. 4,996,855 to have increased maintenance issues, difficulty in use, or failure due to debris that may accumulate in the exposed mechanical portions of most locking mechanism. Additionally, solid waste containers located remotely can be misplaced or even lost by their owners due to the passage of time if infrequently emptied, or if the box is relocated by a third party.

Additionally several patents discuss the general concept of tracking assets using a navigation system, such as the Global Positioning System (“GPS”). For example U.S. Pat. No. 5,588,005, Protocol and mechanism for primary and mutter mode communication for asset tracking, issued to Ali et al. on Dec. 24, 1996, discusses using GPS to track assets and containers because of the value that the containers may have irrespective of any goods being transported. U.S. Pat. No. 5,558,005 further discusses that the navigation positioning system, for example GPS, may be either space based or earth based. Moreover, the location of a navigation positioning system receiver is determined based on the signals received from multiple sources, whether earth or satellite based. As discussed in U.S. Pat. No. 6,108,524, Inbound Message Transmission Device and System for Railcars Asset Tracking Using High Frequency Signaling, issued to Hershey et al. on Aug. 22, 2000, the GPS satellite system uses multiple satellites circling the globe each providing a signal in a specified frequency band, such as the L-Band frequency, using spread spectrum frequency techniques that is received by the GPS receiver, which calculates the location of the devices based on the reception of signals from multiple satellites at one time. As discussed in U.S. Pat. No. 6,108,524, a GPS receiver needs to be in view of multiple satellites to acquire the geographic location of the receiver, i.e., a GPS fix. With a GPS fix, the GPS receiver can identify to within some error parameter, typical several feet or several yards based on the equipment being used, the location of the receiver on the earth. Thus, tracking of an asset can be greatly improved through the use of GPS, or other land or satellite based location technologies.

Finally U.S. Patent Application No. 20050261917, Electronic waste management system, filed by Forget Shield and published on Nov. 24, 2005, discusses electronic systems for managing and automating solid waste hauling and is incorporated by reference herein.

To the best of the knowledge of the inventors of this locking mechanism, however, none of the locking mechanisms or systems in the prior art describe or even suggest the use of a remote locking mechanism to secure a solid waste container without utilizing a traditional mechanical, combination, or cylinder lock. Additionally, the prior art does not describe or suggest integrated system or method of tracking the location of remote solid waste boxes using a box lock.

### SUMMARY OF THE INVENTION

The invention relates in general to a locking mechanism to secure a solid waste container in various locations. Additionally, the invention can also relate to providing a way of tracking a solid waste container, and the ability to manage a company's inventory of boxes.

According to an aspect of the present invention, the solid waste container or box lock includes a lock housing and a lock member where the lock member engages the lock housing in such a manner that the engaged lock housing and lock member partially or completely enclose, encase, encompass, surround, cover, block, or obscure access to the hook located on a solid waste container. Thus, stopping or impeding the ability of a metal loop of a hoist truck to properly engage the hook. The lock housing and lock member may be connected to each other at a point of contact by a hinge, or fit together in some inter-locking fashion, way, or manner.

The box lock further contains a lock assembly located on the lock member that includes an actuator and a lock plate. Based on an input signal, a control circuit operates the actuator to directly or indirectly engage or disengage the lock plate from a corresponding orifice. The input signal can come from a button, key pad, or switch on the box lock, or can be from an external key that may or may not require contact with the box lock to operate. For example, the key could act similar to a remote gate or garage door opener, or it may have a part, shape, or member that matingly connects with a receiver on the box lock. A power source, which may be part of the box lock or external to the box lock, for example being located in the box lock key, provides the power to operate the control circuit and actuator.

In another aspect of the present solid waste container or box lock, the lock assembly may include a pivot member that is connected to the actuator that moves the pivot member between different possible positions. One example may be a pivot member that moves between a first and second position, and then from the second to the first position. In this configuration, the actuator is not directly connected to the lock plate, and instead moves the pivot member, which in turn causes the lock plate to engage or disengage from the corresponding orifice. It is further possible to connect multiple lock plates to the pivot member so that each lock plate may be engaged or disengaged from a corresponding orifice based on the position of the pivot member.

It is still another aspect of the present invention to use one or more actuators in the lock assembly to change the position of the pivot member. For example two actuators, which could be solenoids, electric motors, drives, or other similar mechanisms, that act in opposing directions may be used to move the pivot member between different positions. Thus, engaging or disengaging the lock plates from their corresponding orifices based on which actuator is operated by the control circuit.

It is still another aspect of the present invention that one or more signals may be used to operate the control circuit. For example, different hoist truck drivers could have different signals associated with a driver-assigned key device. It is further possible to have different signals for engaging and disengaging the lock plates from corresponding orifices in a box lock of the present invention. The signals used in the present invention could also be encoded in some manner so that stray signals do not inadvertently operate or trigger operation of the control circuit. This would be especially helpful if the key mechanism operated similar to a garage door opener or remote control.

In another aspect of the present invention, the solid waste container or box lock includes a lock housing, a lock member, an engagement member and a centralizer that engage each other and a hook on a solid waste container such that the box lock partially or completely encases, encloses, encompasses, surrounds, covers, blocks, or obscures access to the hook. Thus, stopping or impeding the ability of the metal loop of a hoist truck to properly engage the hook. The housing and various members of the box lock may be connected to each other at points of contact by a hinge, or fit together in some inter-locking fashion, way, or manner.

The box lock further contains a lock assembly located on the lock member that includes an actuator and a lock plate. Based on an input signal, a control circuit operates the actuator to directly or indirectly engage or disengage the lock plate from a corresponding orifice. A power source provides the power to operate the control circuit and actuator, and this power source may be located internal to or external of the box lock.

It is still another aspect of the present invention to use one or more actuators in the lock assembly to change the position of a pivot member. For example two actuators could act in opposing directions and may be used to move the pivot member between different positions. Thus, engaging or disengaging the lock plates from their corresponding orifices based on which actuator is operated by the control circuit.

In another aspect of the present invention, an external key may be utilized to provide a signal to activate the control circuit of the locking mechanism without the use of either a mechanical cylinder lock or combination lock. Additionally, the external key may use more than one signal to control the control circuit. For example, the external key may use one signal to activate one of the actuators to cause the lock plates to engage a corresponding orifice, and a different signal to activate an actuator to cause the lock plates to disengage the corresponding orifice. Similarly, if one actuator is used, one signal may move the actuator in one direction, and a second signal to move the single actuator in a different direction. Additionally, the signals to activate the control circuit can be customized to a specific set of signals that may be associated with one or more keys, and or one or more persons having the keys. This with the incorporation of some form of electronic memory can allow for a tracking mechanism to identify the key or individual who locked or unlocked the locking mechanism of the solid waste container box lock. By combining this information with an identifier for the solid waste box it would be possible to correlate what key or individual locked or unlocked box lock associated with a solid waste container, and/or the container's location as discussed further below.

The solid waste container lock may be further enhanced by the incorporation of a navigation positioning system receiver and antenna—for example, a GPS receiver and antenna—a memory storage device, an electronic or software clock that maintains time and date, an input to the memory storage device that records the date, time, and location when the control circuit is activated, and an output from the memory storage device to an external data management system that records and stores the data captured by the memory storage device for manipulation and use. Several commercially available and off-the-shelf technologies exist regarding GPS or other geographic locating receivers and antennas. Additionally, memory storage devices are continually becoming more powerful and ever smaller, and include such devices as memory chips, USB drives, flash drives, and various types of disc technology. Still additionally, the use of a software clock to maintain time, calendar day and year is well known in the art of electronic devices and/or software. Finally, the ability to communicate with a memory storage device can be, for example, by direct connection, integrated circuit, cable connection, wireless connection, network connection, blue tooth technology, WiFi, or cellular technology. Additional direct and indirect connections may be possible or become possible in the future.

According to another aspect of the present invention, a method of securing a solid waste container includes providing a housing, a lock member, a power source, a control circuit, an input signal to the control circuit, one or more actuators, a pivot member, one or more lock plates with one or more corresponding orifices. Furthermore, the control circuit can selectively activate a first actuator to move the pivot member from a first position to a second position causing one or more lock plates to engage the corresponding orifices. The control circuit can further selectively activate a second actuator to move the pivot member from the second position to the first position causing the one or more lock plates to disengage the corresponding orifices. When the lock housing is engaged by the lock member it partially or completely encases, encloses, encompasses, surrounds, covers, blocks, or obscures access to the hook located on a solid waste container.

In another aspect of the present invention, the method of securing a solid waste container may include providing an engagement member that works with the lock housing and lock member to partially or completely encase, enclose, surround, cover, block, or obscure access to the hook located on a solid waste container.

In another aspect of the present invention, the method of securing a solid waste container may include providing a memory storage device, a navigation positioning system receiver and antenna, a electronic clock that maintains time and date, an input to the memory storage device to record date, time, and location when the control circuit is activated, and providing an output from the memory storage device to an external data management system that records and stores the information recorded on the memory storage device. Furthermore, the method of securing a solid waste container may include providing a key to provide a signal to operate the control circuit. This input signal can come from a button, key pad, or switch on the box lock, or be from an external key that may or may not require contact with the box lock to operate. For example, the key could act similar to a remote gate or garage door opener, or it may have a part, shape, or member that matingly connects with a receiver on the box lock. Finally a power source, which may be part of the box lock or external to the box lock, provides the power to operate the control circuit and actuator.

### BRIEF DESCRIPTION OF THE DRAWINGS

FIG. 1 is a view of a solid waste container detail and the connection of a metal loop connected to a cable used to hoist the solid waste container onto a hoist truck (not shown).

FIG. 2 is a plan view of the lock member, the engagement member and lock housing of a remote electronic solid waste box locking mechanism constructed in accordance with an embodiment of the present invention in an open position, including dashed lines to show hidden aspects of the remote electronic solid waste box.

FIG. 3 is a plan view of the lock member, the engagement member and lock housing of a remote electronic solid waste box locking mechanism constructed in accordance with an embodiment of the present invention in a closed position, including dashed lines to show hidden aspects of the remote electronic solid waste box.

FIG. 4 is a plan view of an engagement member of a remote electronic solid waste box locking mechanism constructed in accordance with an embodiment of the present invention.

FIG. 5 is an elevation of an engagement member of a remote electronic solid waste box locking mechanism constructed in accordance with an embodiment of the present invention.

FIG. 6 is an elevation of the engagement member shown in relation to the lock housing of a remote electronic solid waste box locking mechanism constructed in accordance with an embodiment of the present invention.

FIG. 7 is an elevation of an engagement member of a remote electronic solid waste box locking mechanism constructed in accordance with an embodiment of the present invention.

FIG. 8 is an elevation of the lock member shown in relation to the lock housing of a remote electronic solid waste box locking mechanism constructed in accordance with an embodiment of the present invention.

FIG. 9 is an elevation of the lock member of a remote electronic solid waste box locking mechanism constructed in accordance with an embodiment of the present invention.

FIG. 9 is a plan view of the lock member of a remote electronic solid waste box locking mechanism constructed in accordance with an embodiment of the present invention.

FIG. 11 is an elevation of the lock member of a remote electronic solid waste box locking mechanism constructed in accordance with an embodiment of the present invention.

FIG. 12 is a plan view of the lock housing with dashed lines to show hidden aspects of the lock housing of a remote electronic solid waste box locking mechanism constructed in accordance with an embodiment of the present invention.

FIG. 13 is an elevation of the lock housing with dashed lines to show hidden aspects of the lock housing of a remote electronic solid waste box locking mechanism constructed in accordance with an embodiment of the present invention.

FIG. 14 is a plan view of the lock housing with dashed lines to show hidden aspects of the lock housing of a remote electronic solid waste box locking mechanism constructed in accordance with an embodiment of the present invention

### DETAILED DESCRIPTION

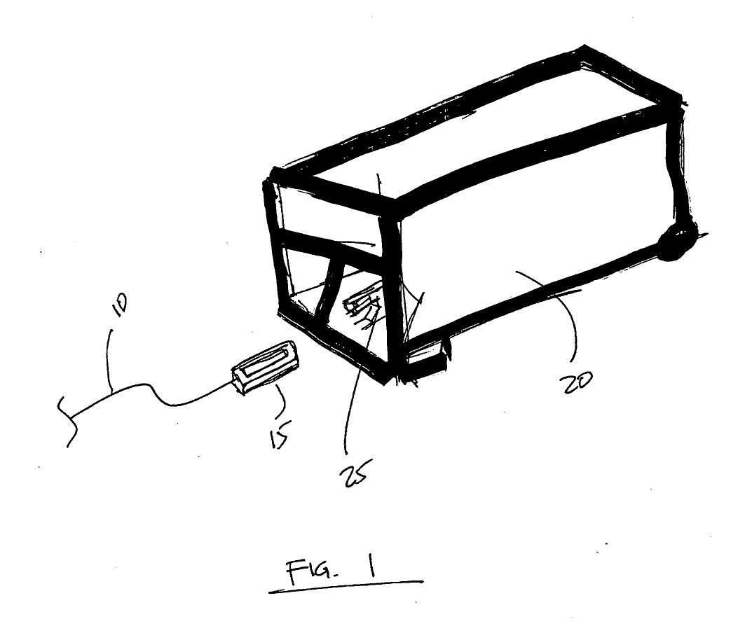

Referring to FIG. 1 it is well known in the solid waste industry that a cable 10 connected to a hoist truck (not shown) having a metal loop 15 can engage a solid waste container or box 20 by metal loop 15 being placed around hook 25, which is general located on the midline of the anterior end of a solid waste container 20. At the posterior end of solid waste container 20 there may be a door, latching gate, or similar structure that may be opened.

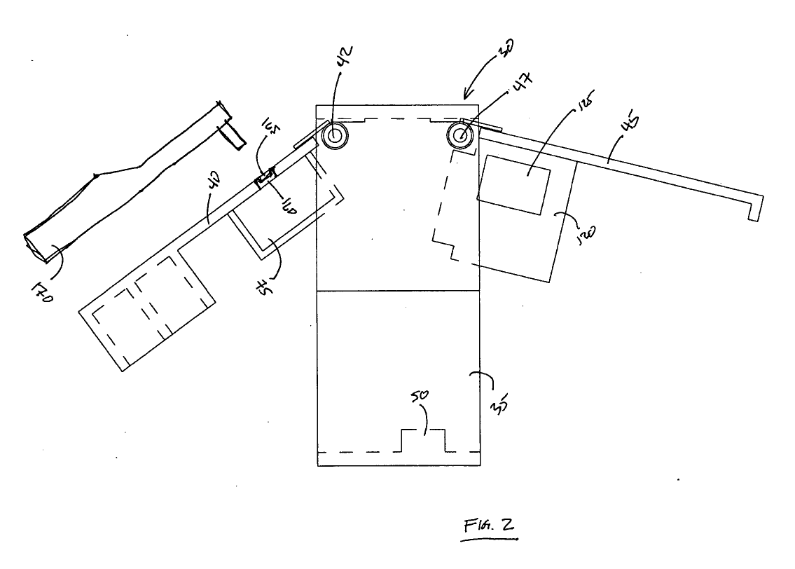

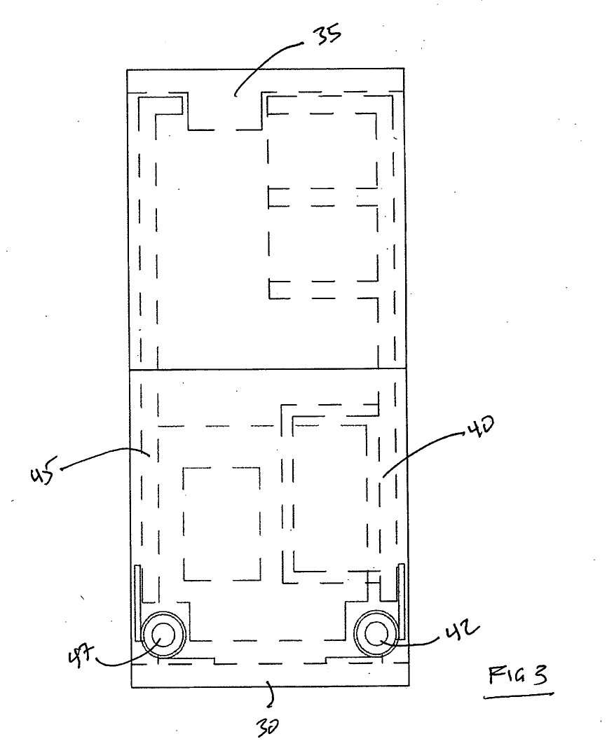

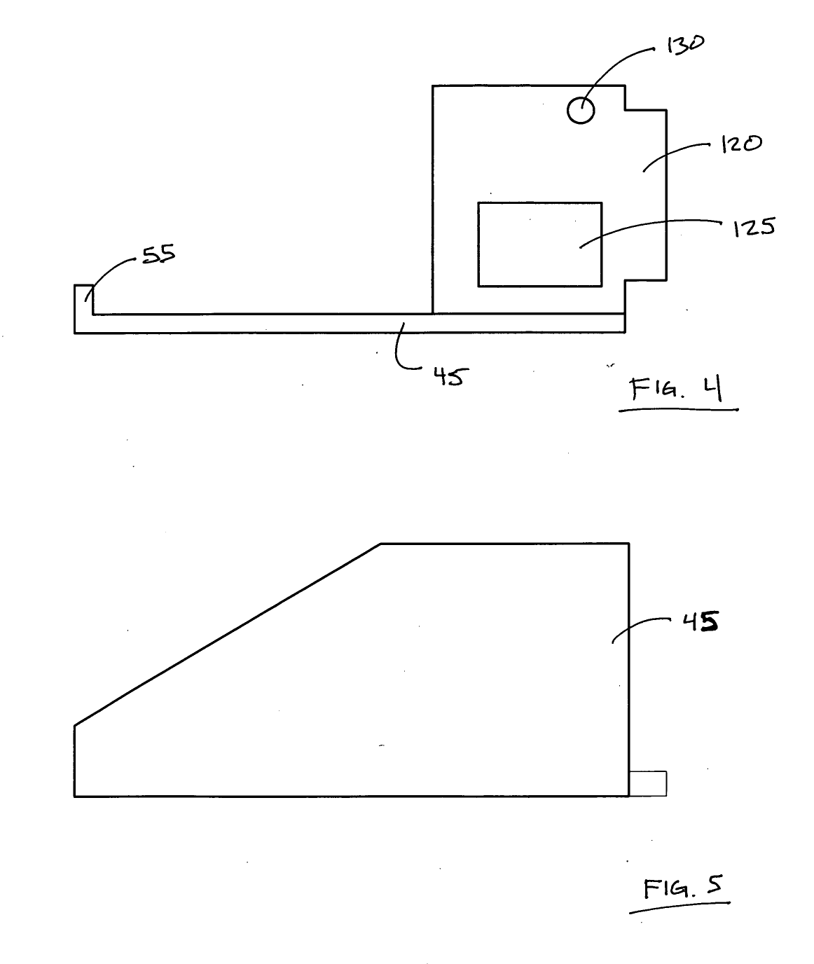

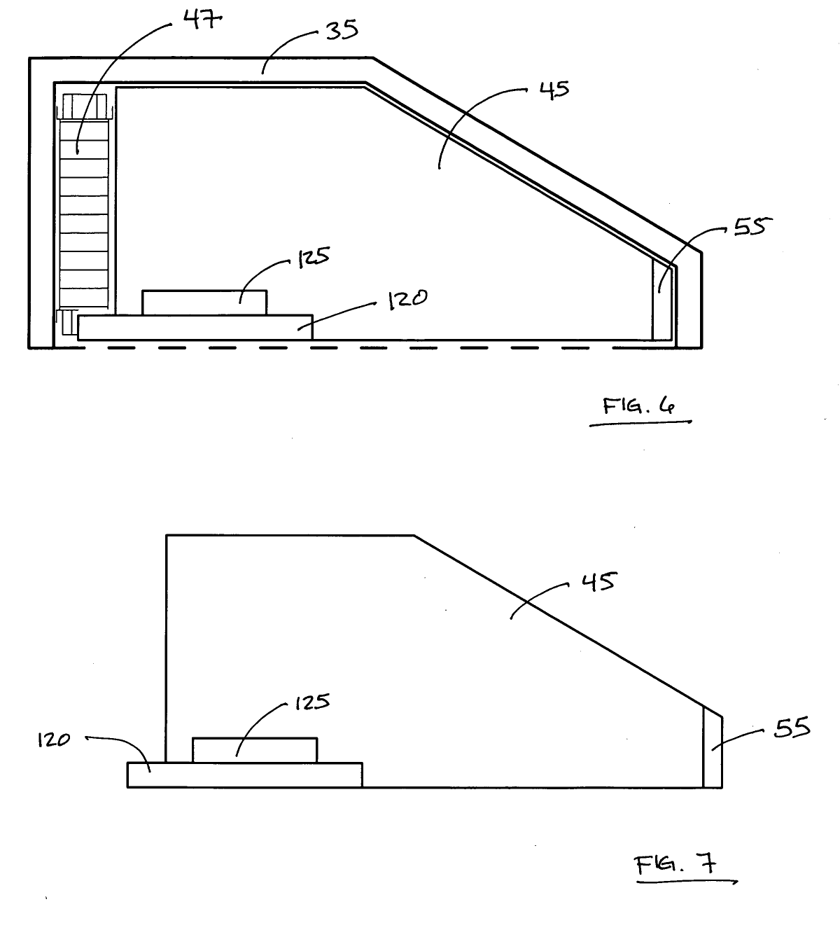

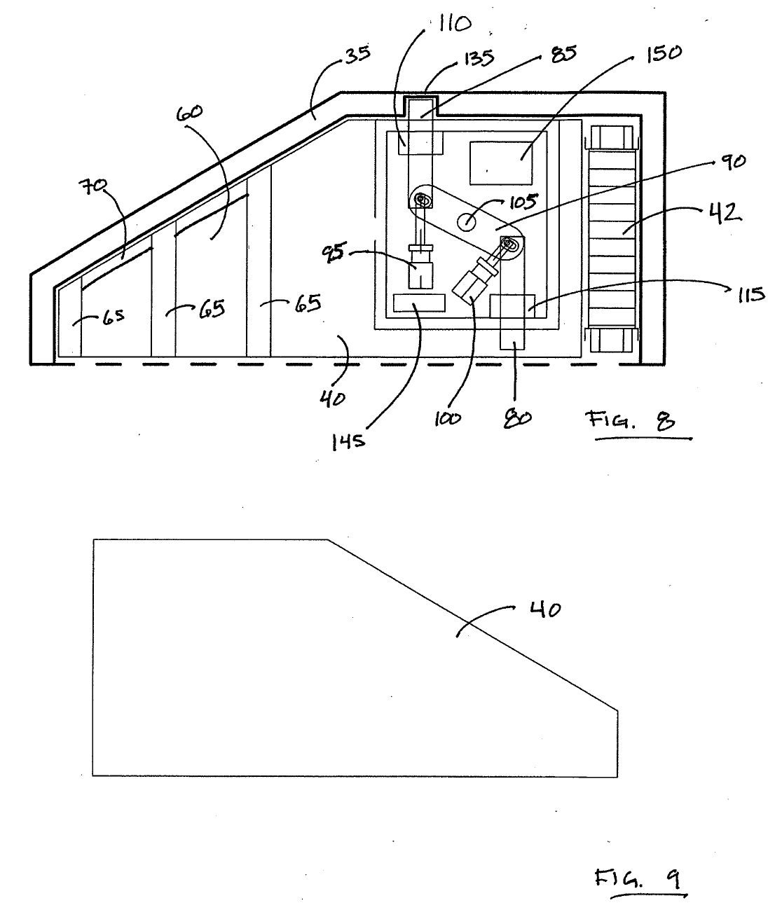

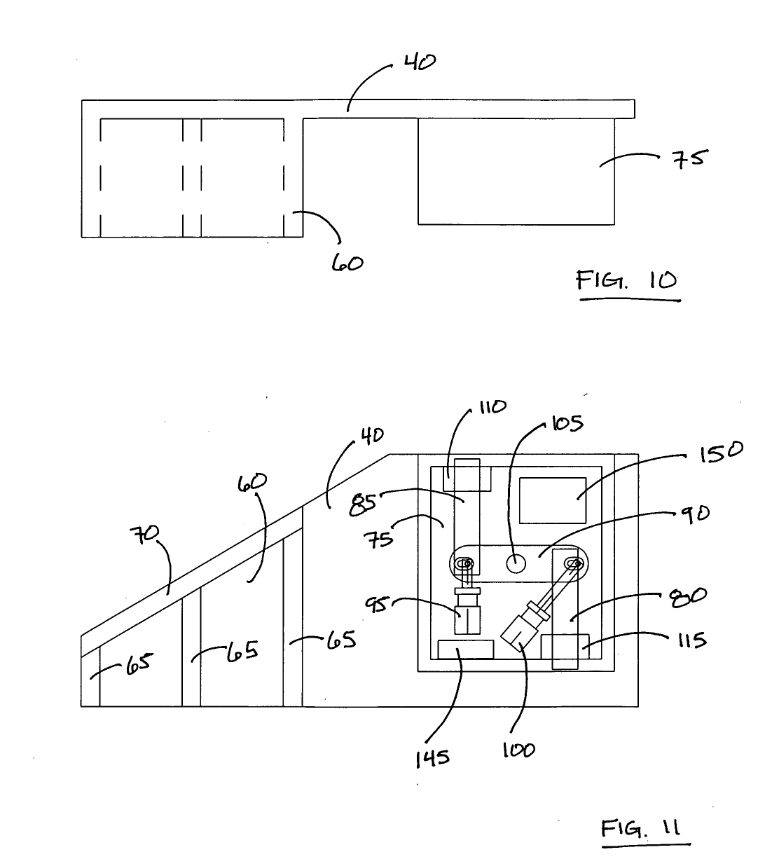

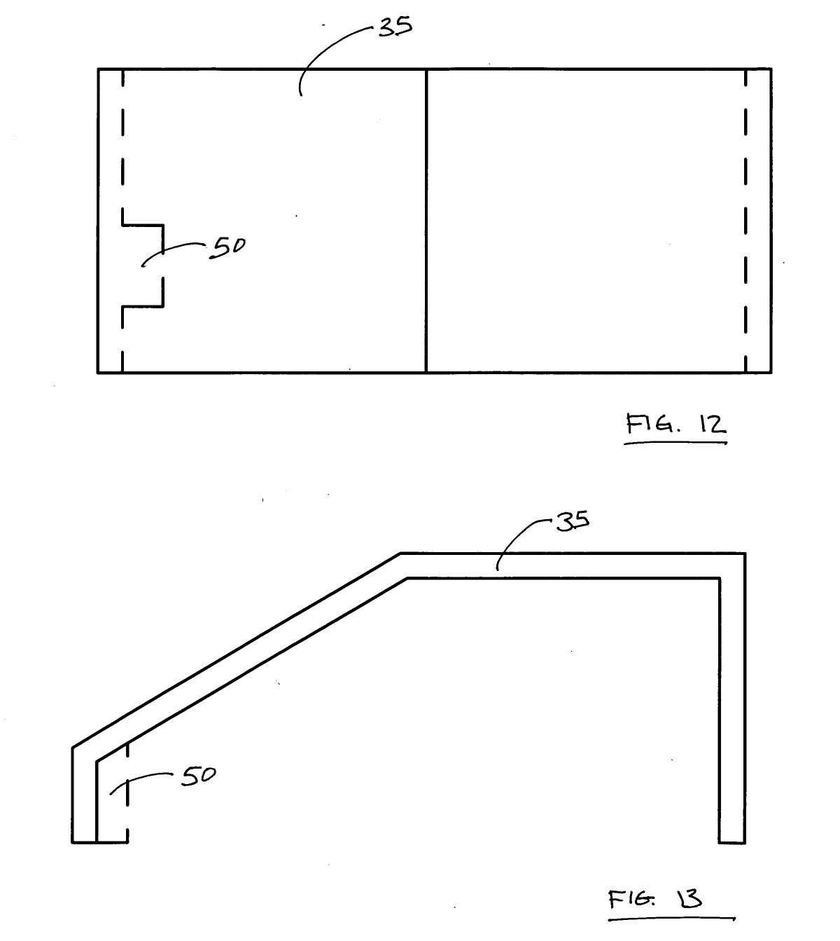

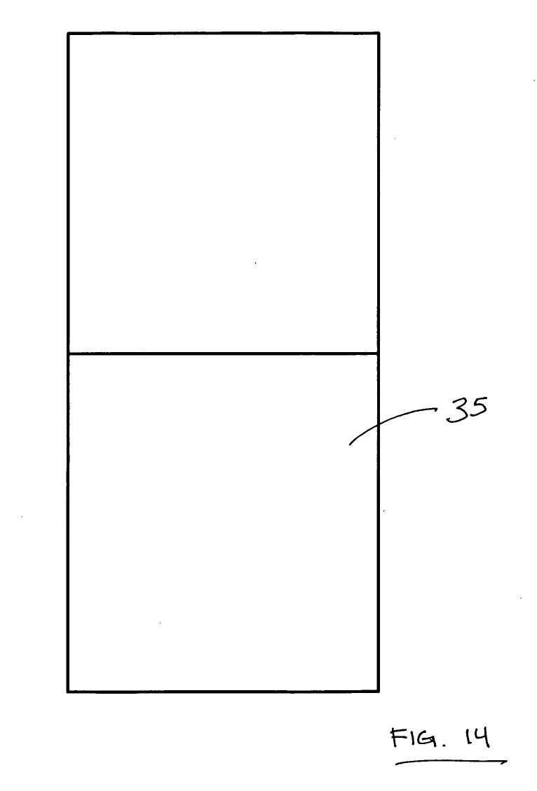

Referring to FIGS. 2 thru 14, solid waste box lock 30 consists of a lock housing 35, a lock member 40 that is connected to the lock housing 35 by a hinge 42, and an engagement member 45 that is connected to lock housing 35 by hinge 47. Alternatively, lock housing 35 and members 40 and 45 may matingly engage each other without the use of hinges, and/or members 40 and 45 may be connected to the housing 35 by some other means including pinned connections, flange and tab connections, or other means or methods of connection. Additionally, it is possible to provide a lock housing 35 that includes a fixed engagement member 45 as a single unit, and only has a movable lock member 40. Similarly, it is possible to provide a lock housing 35 that includes a fixed lock member 40 as a single unit with a movable engagement member 45. Although lock member 40 and engagement member 45 rotate in a horizontal plan when the box lock 30 is in use, it would be readily apparent that a box lock 30 could have one or more members that rotate in a vertical plan relative to box lock 30 in use. For example lock member 40 and engagement member 45 could be a single fixed member, and lock housing 35 could be hinged such that it rotates from a connection at one point of contact between lock housing 35 and the fixed lock member 40 and engagement member 45 similar to a clam shell. Therefore, it is clear that in addition to the embodiments shown or discussed herein, there are numerous different geometries or configurations for box lock 30 that would partially or completely enclose, encase, encompass, surround, cover, or obscure hook 25 so that a box lock 30 could not be removed from hook 25 while in use.

Box lock 30 is ideally constructed from metal or metal alloys—including, but not limited to, iron, steel, stainless steel, titanium, brass, bronze, or carbide—composite materials, or other rigid and durable materials suitable treated for exposure to the elements that can sustain or survive impacts, cutting or other destructive assaults on box lock 30. As with all locking mechanism, box lock 30 can be damaged to the point of failure, but ideally can survive for five or more minutes of an assault by a determined attacker with a crow bar, torch, cutting or welding equipment, or other tools or devices. Those skilled in the art would readily appreciate that the structural elements of box lock 30 can be formed from plate material or stock that is fabricated or formed into the necessary shapes and may include welded, hinged or other connecting mechanism or procedures known in the art of metal working and metal fabrication. It would also be readily understood that the structural members could be forged, cast, sintered, or otherwise constructed, formed or molded into a final shape. While various thicknesses of a suitable material may be used, it is contemplated that the present invention could be constructed of materials having a thickness between ⅛″ and 1″, although other material thicknesses are possible depending on the material. Additionally, different sections of box lock 30 may be fabricated from different materials and/or have different material thickness.

In one of the many embodiments of the present invention, housing 35 includes a centralizer 50 that helps to properly orient box lock 30 about hook 25 when box lock 30 is in use. The engagement member 45 includes a lip 55 that abuts centralizer 50 when box lock 30 is in use. If the width centralizer 50 is increased, then the size of lip 55 may be reduced and/or eliminated. Similarly, if the width of centralizer 50 is decreased, then the size of lip 55 may be increased.

Lock member 40 has a centralizer 60 that helps to properly orient box lock 30 about hook 25, and abuts centralizer 50 and hook 25 when box lock 30 is in use. Centralizer 60 includes one or more support members 65 and a cross member 70 may provide additional structural stability for centralizer 60. Centralizer 60 could be constructed in different orientations to achieve the same result, and cross member 70 may not be need to provide stability for support members 65 in all embodiments of box lock 30.

Contained within lock member 40 is a lock assembly 75 that consists of lock or stab plates 80 and 85, pivot member 90, actuators 95 and 100, pivot 105, and lock guides 110 and 115. Engagement member 45 includes an upward facing shoulder plate 120 that slides under a portion of hook 25 and lock assembly 75 when box lock 30 is in use. The should plate 120 includes an engagement plate 125 that is at least partially under hook 25, and an orifice 130 that can be engaged by lock plate 90 when box lock 30 is in use. Lock housing 35 includes orifice 135 that can be engaged by lock plate 85 when box lock 30 is in use. During use of box lock 30, engagement member 45, engagement plate 125, centralizer 50, centralizer 60 and/or lock assembly 75 properly orient hook 25 within box lock 30 to completely or partially enclose, encase, encompass, surround, cover, or obscure hook 25 so that box lock 30 cannot be removed from hook 25, and a metal loop 15 cannot be placed on hook 25.

Pivot member 90 rotates about pivot 105 depending on the positions of actuators 95 and 100. Furthermore, actuators 95 and 100 engage or disengage lock plates 80 and 85 by moving pivot member 90 between different possible positions of pivot member 90. For example, when actuator 95 is engaged pivot member 90 moves from a first position to a second position. When Actuator 100 is engaged, pivot member 90 moves from the second position back to the first position. As pivot member 90 moves between the first and second position it cause lock plates 80 and 85 to slide forward through lock guides 110 and 115, and lock plates 80 and 85 engage orifices 130 and 135. When pivot member 90 moves from the second position to the first position it cause lock plates 80 and 85 to move backwards through lock guides 110 and 115, and lock plates 80 and 85 disengage from orifices 130 and 135.

Actuators 95 and 100 may be either normally opened or normally closed so long as the actuators are oriented within lock assembly 75 to move pivot member 90 between its different positions. In the development of the present invention the proof of concept for the locking mechanism utilizing lock plates 80 and 85, pivot member 90, and opposed actuators 95 and 100 were a Testco 151094-230 NCNR solenoid.

The power to operate Actuators 95 and 100 is provided by a power source 145, which may be a battery, and is controlled by control circuit 150. Lock interface 160 connects lock assembly 75 with key interface 165. External key 170 may have a part, shape, or member that matingly connects with key interface 165, or may communicate with the control circuit through some wireless or indirect signal similar to a remote control or garage door opener.

When an external key 170 engages key interface 165, an operator can select to move pivot member 90 from the first position to the second position or vice versa using key selection switch 175, which will send a signal to control circuit 150 that will cause lock plates 80 and 85 to either engage or disengage orifices 130 and 135 thus locking or unlocking box lock 30. When box lock 30 is in a locked position, and lock plates 80 and 85 engage orifices 130 and 135, metal loop 15 can not engage hook 25 and, therefore, the solid waste container 20 cannot be loaded onto a hoist truck. When box lock 30 is in an unlocked position, and lock plates 80 and 85 disengage orifices 130 and 135, and box lock 30 can be removed from hook 25 so that metal loop 15 can engage hook 25 and the solid waste container 20 can be loaded onto a hoist truck.

Additionally, in an alternate embodiment key 170 may be configured such that key 170 provides some or all of the power needed to operate actuators 95 and 100, thus minimizing the size of power source 145 or completely eliminating power source 145 from being located in either the lock assembly 75 or box lock 30. Key 170 may also be configured such that it uses one or more electronic signals to move pivot member 90 from the first to the second position, and one or more different electronic signals to move pivot member 90 from the second position to the first position. By using one or more different coded electronic signals, control circuit 150 can provide an enhanced level of security by requiring that the electronic signal used to engage or disengage actuators 95 and 100 is an approved or authorized signal from an authorized key 170.

In another embodiment the key 170 can be a normal lock key where key 170 can be placed in a key interface 165 that is a mechanical switch. When key 170 is turned within key interface 165, the switch is moved between different positions. In this embodiment, when key 170 is turned in key interface 165 a signal is transmitted to the control circuit 150 based on the position of key interface 165. Additionally, the input signal to control circuit 150 could come from a button, key pad, or switch on box lock 30, which could serve as a key interface 165 and cause a signal to operate control circuit 150. Still additionally, external key 170 may or may not require contact with the box lock 30 to operate control circuit 150. For example, key 170 could act similar to a remote gate or garage door opener. In contrast, external key 170 could have a shape that matingly connects with a corresponding shape of key interface 165.

Furthermore, those skilled in the art would readily appreciate that instead of using the two lock plates 80 and 85, the locking assembly 75 could use one or more lock plates depending on the orientation of lock housing 35, lock member 40 and engagement member 45. Furthermore, those skilled in the art would readily appreciate that the locking mechanism could use only one actuator, in combination with one or more lock plates. It is also possible that actuators 95 and 100 could be solenoids, as described above, or could be an electronic motor, drive, or other electro-mechanical mechanisms that directly or indirectly cause the one or more lock plates of box lock 30 of the present invention to engage the one or more corresponding orifices in another member of solid waste box lock 30. For example a two position electronic motor, electric drive, or other electro-mechanical mechanism could move one lock plate, either connected or not connected to a pivot member 90, from a first to second position, or the second to the first position. Thus, it is possible to lock or unlock box lock 30 using one or more lock plates and one or more actuators for moving the one or more lock plates between different positions to engage or disengage the one or more lock plates from the corresponding orifices.

Box lock 30 can be further enhanced by tracking or storing data related to the history of when box lock 30 is locked or unlocked by the incorporation of additional circuitry, software, coding, instructions and/or an electronic memory storage device, such as a flash drive, USB drive, memory chip or disc. It is further possible to incorporate a software clock that is able to track the date and time. If the memory storage device and/or software or electronic clock is included in box lock 30 and/or key 170, the memory storage device can record and store data regarding when a box lock 30 is locked or unlocked by what key 170.

By further incorporating a navigation positioning system receiver and antenna, for example, a GPS receiver and antenna, connected to the memory storage device by direct, wireless, network, blue tooth, cellular, WiFi or other connection, it would be possible to store data regarding the location of where box lock 30 was locked or unlocked by key 170 automatically. If the memory storage device and navigation positioning system receiver and antenna are incorporated into key 170, it would be necessary that a unique identifier for box lock 30 be captured and stored with the other information regarding where and when box lock 30 was locked or unlocked. If incorporated into box lock 30, it may be necessary for box lock 30 to record a unique identifier for key 170 used to lock or unlock box lock 30.

The identification of box lock 30 or key 170 could be completed through either an automatic or manual process that may include, but is not limited to, the use of bar code technology and readers, electronic signals, or alpha-numeric identifiers that are either manually or automatically recorded by user input, digital imaging or photographs, scanning, or RFID tags. This data can then be used to track the location of box lock 30 and key 170 used, and presumably the correlated or related to a solid waste container 20 by downloading the data by direct, wireless, network, blue tooth, cellular, WiFi or other connection from the memory storage device located in either box lock 30 or key 170 to a computer, computer network, electronic handheld device, website, or other external device capable of storing and sorting the data from one or more memory devices associated with box lock 30 or key 170.

One skilled in the art would understand that the implementation of data management system contemplated by the present invention could be achieved through the implementation, installation, customization or modification of various commercially available spread sheets or databases, and/or include customized software, coding, applications or programming in one or more computer programming languages readily known by people skilled in data management software, programming, coding, or systems. The data management system can be located on a specific piece of computer hardware, such as a laptop or work station, or may be located on a networked or shared device, such as network server, or may be located on an internet server, or web based application, platform, thin client, application, software or computer program. Moreover, the data management system may be connected through a direct, integrated, networked, wireless, cellular, WIFi connection or information transfer protocol to one or more publicly or privately available data bases, maps, or other electronic services or information. For example, information regarding maps can be integrated with the information regarding the use of the box lock 30 to map the location and time of use of box lock 30 and/or key 170. Furthermore, if key 170 and box lock 30 have a unique identifiers, this information could be integrated to further track which key 170 locked or , unlocked which box lock 30 at what time, date and location. Presumably, use of key 170 could then be correlated to an individual and thus track the identity of the person who locked or unlocked box lock 30.

Additionally, the tracking features of the present invention could be enhanced by incorporating a transmitter in the box lock 130 that could transmit data regarding its location to the data management system. It would also be possible to use a receiver to receive requests for transmission of location by the transmitter. These features can be accomplished using data transmission over wireless, cellular, WiFi or other communication networks now available or available in the future.

The data management system could also be incorporated into an internet based web site, or other online media, such that different persons or entities could access a common data management system from various or dispersed geographic locations. The data management system could also be used by one or more persons or entities to track one or more solid waste containers owned by either the same or different entities. If the data management system were available to be accessed through a publicly available website or other online media, one skilled in the art would readily understand that it would be possible to incorporate security procedures, cookies, customized URLs, HTML coding, software, programs, applications, passwords, or other encryption or security techniques to protect the data stored in the data management system from unauthorized or improper modification, alteration, copying, review, or deletion.

The structure of the logic of the present invention as it relates to the software, programming, coding or logic or integrated circuits for the clock and inputting or exporting the stored data regarding date, time and location of control circuit 150 of box lock 30 being activated by computer programming, software, coding or logic or integrated circuit would be readily appreciated by those skilled in the art. Manifestly, the invention is practiced in its essential embodiment by a machine component that renders the program code elements in a form that instructs a digital processing apparatus to perform a sequence of function steps corresponding to those described.

It is important to note that, while the present invention has been, and will continue to be, described in the context of a fully functional computer system, those skilled in the art will appreciate that the present invention is capable of being distributed as a program product or application in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, USB drives, flashdrives, memory chips, and transmission-type media such as digital and analog communication links.

Additionally, those skilled in the art would readily appreciate that the navigation positioning receiver and antenna could be incorporated into key 170, and the memory storage device could track when and where key 170 was used to lock and/or unlock box lock 30. By further incorporating some method of coding, transmitting or storing the unique identifier for solid waste box lock 30 and/or key 170, for example through the use of RFID tag and reader, bar code and reader, manual entry code, or other electronic feature or signal that is communicated by direct, wireless, network, blue tooth, cellular, WiFi or manual input between a specific box lock 30 and a specific key 170, key 170 could identify or otherwise associate the data of when and/or where box lock 30 is locked or unlocked.

Still additionally, key 170 could operate like a standard garage door opener and transmit a coded signal to box lock 30 having a receiving antenna and control circuitry that would activate control circuit 150 and by engaging an actuator 95 to move pivot member 90 from either a first position to a second position, or the second position to the first position thus locking or unlocking box lock 30 without a direct or physical contact between key 170 with box lock 30.

One skilled in the art would readily understand that box lock 30 could have different orientations that include a lock assembly 75 having one or more actuators, and one or more lock plates that each engage one or more orifices to secure box lock 30. Additionally, box lock 30 could have one or more lock assemblies that are controlled by control circuit 150. Thus, having described the invention above, various modifications of the techniques, procedures, components and equipment will be apparent to those skilled in the art. It is intended that all such variations within the scope and spirit of the appended claims be embraced thereby.

1. An apparatus for securing a solid waste container, comprising:
a lock housing;
a lock member that engages the lock housing to encase a hook on the solid waste container;
a power source;
a control circuit;
an actuator;
a lock plate that engages an orifice; and
wherein the control circuit selectively activates the actuator to engage or disengage the lock plate with the orifice based on an input signal.

2. The apparatus of claim 1 for securing a solid waste container, further comprising:
a pivot member in contact with the actuator and in contact with the lock plate;
wherein the actuator changes the position of the pivot member, which engages or disengages the lock plate from the orifice.

3. The apparatus of claim 2 for securing a solid waste container, further comprising:
the control circuit selectively activates the actuator to change the position of the pivot member from either a first position to a second position, or from the second position to the first position.

4. The apparatus of claim 1 for securing a solid waste container, further comprising:
a key that generates the input signal to activate the control circuit.

5. The apparatus of claim 1 for securing a solid waste container, further comprising:
a navigation positioning system receiver and antenna;
a memory storage device;
a clock that maintains time and date;
an input to the memory storage device to record information regarding date, time, and location when the control circuit is activated; and
an output from the memory storage device to an external data management system that records and stores the information recorded on the memory storage device.

6. The apparatus of claim 1 for securing a solid waste container, further comprising:
a second actuator;
a second lock plate;
a second orifice; and
a pivot member in contact with the actuator, the second actuator, the lock plate, and the second lock plate.

7. The apparatus of claim 6 for securing a solid waste container, further comprising:
wherein the control circuit selectively activates the actuator to change the position of the pivot member from a first position to a second position causing the lock plate to engage the orifice, and the second lock plate to engage the second orifice; and
wherein the control circuit selectively activates the second actuator to change the position of the pivot member from the second position to the first position causing the lock plate to disengage the orifice, and the second lock plate to disengage the second orifice.

8. The apparatus of claim 7 for securing a solid waste container, further comprising:
a key that generates the input signal to activate the control circuit.

9. The apparatus of claim 7 for securing a solid waste container, further comprising:
a navigation positioning system receiver and antenna;
a memory storage device;
a clock that maintains time and date;
an input to the memory storage device to record information regarding date, time, and location when the control circuit is activated; and
an output from the memory storage device to an external data management system that records and stores the information recorded on the memory storage device for tracking the location of the solid waste container.

10. A lock for securing a solid waste container, comprising:
a housing;
a lock member;
an engagement member;
a centralizer;
a power source;
a pivot member in contact with a first actuator, a second actuator, and a first lock plate;
an input signal to operate a control circuit that selectively activates either the first actuator or the second actuator to change the position of the pivot member, and engaging or disengaging the first lock plate with a first orifice; and
wherein the housing, the lock member, the engagement member and the centralizer engage each other to encase a hook on the sold waste container.

11. The lock for securing the solid waste container of claim 10, further comprising:
a second lock plate in contact with the pivot member;
a second orifice;
wherein the control circuit selectively activates the first actuator to move the pivot member from a first position to a second position causing the first lock plate to engage the first orifice, and the second lock plate to engage the second orifice; and
wherein the control circuit selectively activates the second actuator to move the pivot member from the second position to the first position causing the first lock plate to disengage the first orifice, and the second lock plate to disengage the second orifice.

12. The lock for securing the solid waste container of claim 10, further comprising:
a key that generates the input signal to operate the control circuit.

13. The lock for securing the solid waste container of claim 10, further comprising:
a navigation positioning system receiver and antenna;
a memory storage device;
a clock that maintains time and date;
an input to the memory storage device to record information regarding date, time, and location when the control circuit is activated; and
an output from the memory storage device to an external data management system that records and stores the information recorded on the memory storage device.

14. The apparatus of claim 10 for securing the solid waste container, further comprising:
a second lock plate in contact with the pivot member;
a second orifice;
a navigation positioning system receiver and antenna;
a memory storage device;
a clock that maintains time and date;
an input to the memory storage device to record information regarding date, time, and-location when the control circuit is activated;
an output from the memory storage device to an external data management system that records and stores the information recorded on the memory storage device for tracking the location of the solid waste container;
a key that generates the input signal to operate the control circuit;
wherein the control circuit selectively activates the first actuator to move the pivot member from a first position to a second position causing the first lock plate to engage the first orifice, and the second lock plate to engage the second orifice; and
wherein the control circuit selectively activates the second actuator to move the pivot member from the second position to the first position causing the first lock plate to disengage the first orifice, and the second lock plate to disengage the second orifice.

15. A method of securing a solid waste container, comprising the steps of:
providing a housing, a lock member, a power source, a control circuit, an input signal to the control circuit, a first actuator, a second actuator, a pivot member, a first lock plate, and a first orifice;
wherein the control circuit selectively activates the first actuator to move the pivot member from a first position to a second position causing the first lock plate to engage the first orifice;
wherein the control circuit selectively activates the second actuator to move the pivot member from the second position to the first position causing the first lock plate to disengage the first orifice; and
wherein the housing and the lock member encase a hook on the sold waste container.

16. The method of securing the solid waste container of claim 15, further comprising the steps of:
providing an engagement member; and
wherein the housing, the lock member, and the engagement member encase the hook on the sold waste container.

17. The method of securing the solid waste container of claim 16, further comprising the steps of:
providing a second lock plate; and
providing a second orifice.

18. A method of securing the solid waste container of claim 15, further comprising the steps of:
providing a memory storage device;
providing a navigation positioning system receiver and antenna;
providing a clock that maintains time and date;
providing an input to the memory storage device to record date, time, and location when the control circuit is activated; and
providing an output from the memory storage device to an external data management system that records and stores the information recorded on the memory storage device.

19. A method of securing the solid waste container of claim 16, further comprising the steps of:
providing a key that causes the input signal to operate the control circuit.

20. A method of securing the solid waste container of claim 15, further comprising the steps of:
providing an engagement member;
providing a second lock plate;
providing a second orifice;
providing a key that causes the input signal to operate the control circuit;
providing a memory storage device;
providing a navigation positioning system receiver and antenna;
providing a clock that maintains time and date;
providing an input to the memory storage device to record date, time, and location when the control circuit is activated;
providing an output from the memory storage device to an external data management system that records and stores the information recorded on the memory storage device for tracking the location of the solid waste container; and
wherein the housing, the lock member, and the engagement member encase the hook on the sold waste container.
